(19) United States
(12) Patent Application Publication
(10) Pub. No.: US 2025/0150460 A1
(43) Pub. Date: May 8, 2025

(54) SELECTIVELY RESTRICTING INTERACTION WITH APPS ON A DIGITAL DEVICE

(71) Applicant: Refocus On Live B.V., Delft (NL)

(72) Inventors: Jorn Rigter, Delft (NL); Tim Smits, Delft (NL)

(21) Appl. No.: 19/012,863

(22) Filed: Jan. 8, 2025

(30) Foreign Application Priority Data
Feb. 21, 2020 (NL) 2024974

(51) Int. Cl. H04L 9/40

(52) U.S. Cl. CPC H04L 63/108; H04L 63/102

(57) ABSTRACT

A computer-implemented method selectively restricts interaction with apps installed on a digital device, e.g. a smartphone. The method may include selecting a first set of one or more apps, e.g. distracting apps storing information identifying a key device with the launcher, and the launcher switching between a first operation mode and a second operation mode in response to detecting a connection between the digital device and the key device. In the first operation mode, e.g. a ‘restricted’ operation mode, the launcher prevents the apps in the first set of selected apps from running in the foreground and the launcher blocks notifications originating from an app in the first set of selected apps. In the second operation mode, the launcher does not prevent apps in the first set of selected apps from running in the foreground.

### CROSS-REFERENCE TO RELATED APPLICATIONS

This application is a continuation of U.S. patent application Ser. No. 17/124,228 (Attorney Docket No. UNPLUQ001) entitled “SELECTIVELY RESTRICTING INTERACTION WITH APPS ON A DIGITAL DEVICE,” and filed on 2020 Dec. 16, which claims the benefit of foreign application No. NL 2024974 entitled “SELECTIVELY RESTRICTING INTERACTION WITH APPS ON A DIGITAL DEVICE,” and filed on 2020 Feb. 21, each of which is hereby incorporated by reference.

### FIELD OF THE INVENTION

The disclosure relates to a method for selectively restricting interaction with apps installed on a digital device and in particular, though not exclusively, to methods and systems for selectively restricting interaction with apps installed on a digital device, and a computer program product enabling a computer system to perform such methods.

### BACKGROUND

The discussion below is merely provided for general background information and is not intended to be used as an aid in determining the scope of the claimed subject matter.

Digital devices have been proven to be distracting to its users, which negatively affects their focus. Furthermore, these digital devices are shown to have a negative impact on mental health and sleep when used excessively. Such devices can be a bane in a workplace leading to varying effects such as loss of output from workers and in extreme cases, physical harm to workers when they're distracted while performing hazardous tasks such as when operating a forklift.

Prior art relating to the field of reducing distraction from digital devices can mainly be found in patents for reducing distraction from applications and digital devices while driving.

Such a device with a distraction reducing function is known from US2015/0099495 A1. US2015/0099495 A1 describes how to reduce distraction from apps or a smartphone while driving. It describes the potential of apps to be distracting to a driver. US2015/0099495 A1 uses a controller to “control the operation of the app being executed on a Smartphone” based on whether the app is “car safe”, the key device used to input data to the app and the output from the app.

US2015/0099495 A1 further describes the improved safety of the driver when using the invention. “The apps should not unduly distract the driver from operation of the vehicle while maintaining the apps utility.” Apps that are not distracting according to the “car safe” label can be used all the time. Distracting apps will be limited for use by the controller unit.

This known method described above by US2015/0099495 A1 is, however, limited to use when driving a vehicle. When the objective is to limit the distraction from digital devices in a context outside of a moving vehicle, this method comes in short.

Also, determining the “car safe” label makes sense while driving, since the user's distraction can be objectively measured. In a different context, however, determining what will be distracting for a user is relatively subjective. In the described method by US2015/0099495 A1, there is no flexibility in labelling the distracting apps, nor can the distracting apps be chosen or personalized by the user. For example, when the objective is to focus in a work environment, one might want to label distracting apps differently from when the objective is to drive a vehicle without distractions.

The present invention aims to resolve at least some of the problems and disadvantages mentioned above. The aim of the invention is to provide a method which eliminates those disadvantages. The present invention targets at solving at least one of the aforementioned disadvantages.

The invention thereto aims to provide a solution for reducing the distraction from digital devices in contexts chosen by the user. The invention also aims to provide a solution for a personalizable way to choose which apps are distracting apps.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including a functional or an object oriented programming language such as Java™, Scala, C++, Python or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer, server or virtualized server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), or graphics processing unit (GPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In a first aspect, the invention relates to a method for selectively restricting interaction with apps installed on a digital device, e.g. a smartphone. The digital device may comprise a launcher. The method may comprise selecting a first set of one or more apps and storing information identifying the first set of selected apps with the launcher, storing information identifying a key device with the launcher, and the launcher switching between a first operation mode and a second operation mode in response to detecting a connection between the digital device and the key device. In the first operation mode, e.g. a ‘restricted’ operation mode, the launcher may prevent the apps in the first set of selected apps from running in the foreground and the launcher may block notifications originating from an app in the first set of selected apps. In the second operation mode, the launcher may not prevent apps in the first set of selected apps from running in the foreground, and the launcher may not block notifications originating from an app in the first set of selected apps.

Selecting a set of one or more apps may also include indicating all apps that should not be selected, i.e. selecting may include both ‘whitelisting’ and ‘blacklisting’. In an example, the first set of selected apps may include apps that are considered distracting, for example social media apps. Thus, a user will not receive notifications from distracting apps and will not be able to use distracting apps unless the user makes a conscious choice to do so. Consequently, the user will be distracted less, and may therefore be e.g. more productive or may better focus on things the user considers meaningful. By not blocking apps that are not selected, the user may still use all relevant capabilities of the digital device. For example, the user may receive a notification when a message is received by a work-related app, but not receive a notification when a message is received by a social app.

In an embodiment, the launcher preventing a selected app from running in the foreground may comprise determining information identifying one or more apps running in the foreground, and if the information identifying at least one app running in the foreground matches stored information identifying a selected app, bringing the launcher to the foreground and preferably outputting a message to the user, e.g. a notification or an Android ‘Toast’. By bringing the launcher to the foreground, the user will be prevented from interacting with the restricted, e.g. distracting, app.

In an embodiment, the launcher preventing a selected app from running in the foreground may comprise determining information identifying one or more apps running in the foreground, and if the information identifying at least one app running in the foreground matches stored information identifying a selected app, displaying an overlay over the selected app, the overlay preferably making the selected app invisible to the user and/or preventing user interaction with the selected app.

In an embodiment, the launcher blocking notifications comprises the launcher receiving a notification, the launcher determining information identifying which app created the notification and if the information identifying the app that created the notification matches stored information identifying a selected app, the launcher cancelling the notification. Thus, the user will not be distracted by notifications from selected apps. However, notifications from unselected apps, e.g. apps that are relevant for a task the user is pursuing, are still presented to the user.

In an embodiment, the launcher blocking notifications may further comprise the launcher storing information associated with the notification. In this embodiment, the launcher switching from the first operation mode to the second operation mode may further comprise the launcher outputting at least part of the stored information associated with the notification. Thus, when the launcher blocks a notification and later switches to an unrestricted operation mode, or at least an operation mode in which the app that created the notification is no longer restricted, the launcher may show the blocked notification, or certain information about the blocked notification such as the name and/or icon of the app that created the notification and the time when the notification was blocked. The notification may be received by a notification listener, which may be registered with an operating system on the device.

In an embodiment, detecting a connection between the digital device and the key device may comprise receiving a connection event, determining information identifying the connected device and comparing the determined information with the stored information identifying the key device, and determining whether the connection event is associated with the connected device being connected or with the connected device being disconnected. A connection event may be related to e.g. a device being connected or a device being disconnected. An event broadcaster may be a part of the operating system for broadcasting events. The launcher may be registered with the operating system, e.g. using a manifest file, to receive predetermined events from the event broadcaster.

In an embodiment, the key device may be a physical device, preferably a USB device, an audio jack device, a Bluetooth device or an NFC device. In an embodiment, the information identifying the key device may comprise one or more of a vendor ID and a device ID stored on the key device. Using a physical key device creates a barrier to distraction for the user.

In an embodiment, the key device may be a virtual device, preferably a Wi-Fi device or GPS device. In an embodiment, the key information may comprise one or more of an SSID and location information. This way, the operation mode can be automatically selected, e.g. a first mode for at home, a second mode for at the office, and optionally a third mode for other locations.

In an embodiment, the method may further comprise selecting a second set of one or more apps and storing information identifying the second set of selected apps with the launcher, and defining a third operation mode. In the third operation mode, the launcher may prevent the apps in the second set of selected apps from running in the foreground and the launcher may block notifications originating from an app in the second set of selected apps. This way, suitable operation modes for different situations may be defined, e.g. a first operation mode for at home, a second operation mode for unrestricted access, and a third mode for at the office. For example, a user may indicate that entertainment apps should be restricted during office hours, while work-related apps should be restricted outside office hours. Using the key device, the user may still access an unrestricted operation mode, e.g. when an important work e-mail is expected one evening.

In an embodiment, the method may further comprise defining operation mode parameters, preferably location information, time information, date information, or network information, in association with the third operation mode, and switching between the first operation mode and the third operation mode based on the defined operation mode parameters. This way, the use may automatically switch between restricted modes.

In an embodiment, the method may further comprise the launcher in the first operation mode using display colours from a first colour palette, preferably a greyscale palette, and the launcher in the second operation mode using display colours from a second colour palette, preferably a full-colour palette. This way, the user is less easily distracted by the unappealing appearance of the digital device, compared to the attention-grabbing colour designs of some apps. In an embodiment, the launcher may, in the first operation mode, hide icons associated with the first set of selected apps, and, in the second operation mode, display icons associated with the first set of selected apps, e.g. in a home screen.

In a second aspect, the invention is further related to a device, preferably a smartphone, comprising a memory storing a launcher and one or more apps, a processor coupled to the memory, and a connector for communicatively coupling the device to a key device, wherein the processor is configured to perform executable operations comprising: selecting a first set of one or more apps and storing information identifying the first set of selected apps with the launcher; storing information identifying a key device with the launcher; and the launcher switching between a first operation mode and a second operation mode in response to detecting a connection between the digital device and the key device. In the first operation mode, the launcher may prevent the apps in the first set of selected apps from running in the foreground and the launcher may block notifications originating from an app in the first set of selected apps. In the second operation mode, the launcher does not prevent apps in the first set of selected apps from running in the foreground, and the launcher does not block notifications originating from an app in the first set of selected apps. The device may be further configured to execute any of the method steps indicated above.

In a further aspect, the invention is further related to a key device comprising a memory for storing key information and a connector, preferably a USB connector, more preferably a USB type C connector or a USB-micro connector, for connecting to a digital device according to an embodiment in this disclosure.

Thus, the embodiments in this disclosure are related to limiting the usage of a digital device for people. More specifically, one possible way to achieve the goal is through a launcher that changes its operation mode based on a connection with a key device.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“Digital device” refers to any computing device which is utilized by a user to provide abilities such as placing calls, running productivity and entertainment applications. A smartphone, a tablet, and a Laptop are examples of such computing devices.

“App” refers to any piece of software installed on the digital device.

“Key” refers to any physical or virtual device that may be connected to the digital device using either a wired or wireless connection, including via USB, NFC, AUX, Wi-Fi, Bluetooth, G.P.S, Infrared, Li-Fi or any other current or future possibility to access and provide input to the digital device.

“Launcher” refers to any software configuration on the digital device through which a user may control the execution of apps on the digital device. The launcher may act as a visual interface between the device and the user wherein the user can launch other applications, access settings and perform other tasks with the digital device. An example of such a launcher is the Google Now Launcher.

“Operating system” refers to any possible configuration of the system that's operating on the digital device. This includes, but is not limited to, the Android operating system, iOS operating system and Windows operating system.

“Entertainment mode” refers to using the digital device for entertainment purposes. This can include purposes of gaming, social media, messaging and similar applications.

“Productivity mode” refers to using the digital device for productivity purposes. This can include purposes of emailing, calling, messaging and similar applications. Note that what is perceived as Productivity mode and what is perceived as Entertainment mode may differ between different users and between different contexts of usage.

“Distraction mode” refers to using the digital device in “Entertainment mode” when it should be used in “Productivity mode”. It can also refer to times when the user feels like they are supposed to or have the desire to not use their digital device but are using it either in the “Productivity mode or in in the “Entertainment mode”

“Functionality mode” refers to a specific operation mode within the software and the functionalities the software allows within this operation mode. An example could be, but is not limited to, “sports” operation mode, in which certain functionality of the digital device is restricted, or “focus” operation mode in which certain functionality of the digital device is restricted, and where it is clear that the operation modes are distinctive in their restrictive capacity, meaning that they limit different functionality of the digital device in the different operation modes.

“Limited Functionality mode” refers to the operation mode in which the software is limited for use. For example, certain apps on the digital device might be unavailable to open, the software might display the user interface in greyscale and certain notifications might be blocked.

“Full Functionality mode” refers to the operation mode in which the software is fully functional for use. For example, all apps on the digital device are available, the software might display the user interface in full colour and all notifications are shown to the user.

“Overlay” refers to any software view which is laid out over a previous software view. For example, if a social media app is showing its feed to the user, an overlay could be placed over the feed, to block the feed from the user's sight. This may include a so-called toast in an Android OS.

The present invention concerns with reducing the use of a digital device in its “Distraction mode”. Digital device users are becoming more conscious of the impact these devices have on their daily life leading to loss of productivity, loss of personal connections, reduced attention span, loss of sleep and several other negative consequences. US2015/0099495 A1 describes a solution to reduce the “Distraction mode” by forcing a smartphone to enter into “car-safe” operation mode when the user enters a car. This doesn't solve the constant distractions for the user in various other scenarios and more importantly it doesn't offer the user a possibility to customize the software or applications which are in the “Entertainment mode” or are in the “Productivity mode” and even more importantly, doesn't offer a solution to modify the state of the digital device by using a “key”.

The present invention solves this problem by using a custom “launcher” which modifies the “digital device” to enter into an anti-“Distraction mode” when the user enters the “key”. By inserting the key and by having anti-distraction “launcher”, the user can take control of his digital device. In the present invention, the launcher software allows a user to choose which applications are for “Entertainment mode” and which application are for the “Productivity mode”. Furthermore, the user can choose the contexts in which they want to use their digital device in one operation mode or another. These contexts can vary with respect to temporal or spatial orientation of the user. When, for example, the user prefers to stay in “Productivity mode” in his work-place and prefers to stay in “Entertainment mode” at his home the “launcher” only allows those applications which are deemed by the user to be productive or entertaining. If the user wants to override these controls and use their “digital device” in an operation mode where it is not supposed to be in based on the context, then they can do it by making the conscious act of adding the “key” to their “digital device” which for example can be a pluggable USB C dongle but is not limited to other forms of input as covered by the term “key”. Hence with the combination of the custom “launcher” and the “key”, the user gains controls of their “digital device” and enhance their performance for the context they're in.

The invention may also relate to a computer program or suite of computer programs comprising at least one software code portion or a computer program product storing at least one software code portion, the software code portion, when run on a computer system, being configured for executing any of the method steps described above.

The invention may further relate to a non-transitory computer-readable storage medium storing at least one software code portion, the software code portion, when executed or processed by a computer, is configured to perform any of the method steps as described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

The following description of the figures of specific embodiments of the invention is merely exemplary in nature and is not intended to limit the present teachings, their application or uses. Throughout the drawings, corresponding reference numerals indicate like or corresponding parts and features.

FIGS. 1A and 1B schematically depict a digital device, according to an embodiment of the invention

FIG. 2 depicts a flow diagram for selectively restricting interaction with apps installed on a digital device according to an embodiment of the invention;

FIG. 3 depicts a flow diagram for starting up a launcher according to an embodiment of the invention;

FIG. 4 depicts a flow diagram for selectively blocking notifications according to an embodiment of the invention;

FIG. 5 depicts a flow diagram for displaying information associated with selectively blocked notifications, according to an embodiment of the invention;

FIGS. 6A and 6B depict flow diagrams for selectively preventing an app from running in the foreground according to an embodiment of the invention;

FIGS. 7A and 7B depict flow diagrams for retrieving an app running in the foreground according to an embodiment of the invention;

FIG. 8 depicts a flow diagram for switching operation modes in response to a key device being connected or disconnected according to an embodiment of the invention;

FIG. 9 depicts a flow diagram for defining an operation mode according to an embodiment of the invention;

FIG. 10 is a block diagram illustrating an exemplary data processing system that may be used for executing methods and software products described in this application.

FIG. 11 depicts a flow diagram for blocking launching of applications when a key device is not near a user device on digital devices running an Apple operating system, according to an embodiment of the invention.

### DETAILED DESCRIPTION

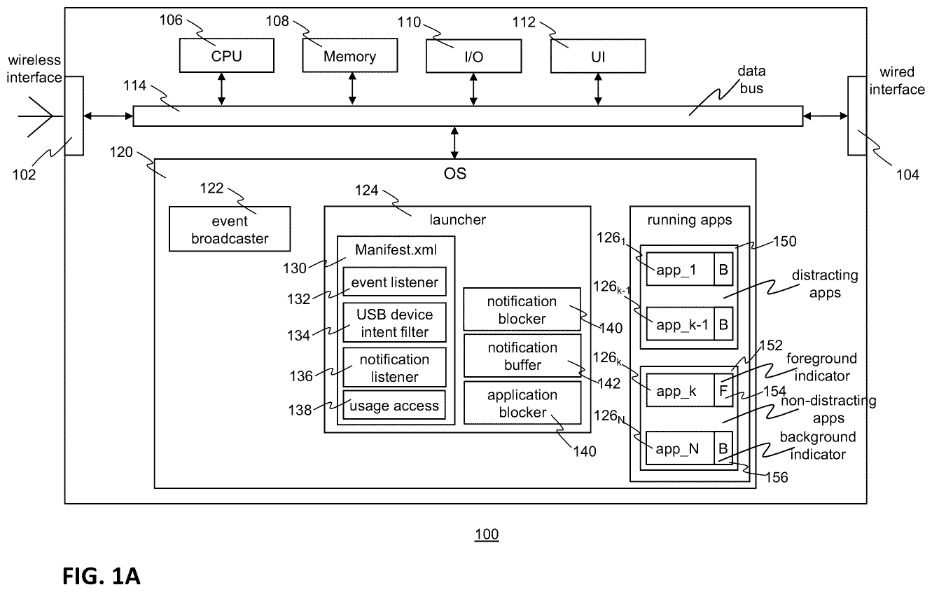

FIG. 1A schematically depicts a digital device 100, e.g. a smartphone, tablet, or laptop, according to an embodiment of the invention. The digital device may comprise a wireless interface 102 and a wired interface 104, configured for communication with one or more external devices. The digital device may further comprise a processor 106 coupled to a memory 108 and input/output (I/O) units 110 via a data bus 114. The I/O units may receive input from a user and provide output to the user via a user interface 112.

Operation of the digital device may be controlled by an operating system (OS) 120. The operating system may control communication between hardware elements 102-112 and applications (apps) 124,1261-N running on the device. A specific application that may be run on the digital device is a launcher 124. A launcher is an application that may be used to launch other apps 1261-N. The launcher may be automatically loaded by the operating system when the digital device is booted. Communication between the launcher 124 and the other apps 1261-N usually goes through the operating system.

A manifest file 130 may be associated with the launcher 124. The manifest file may define which permissions the launcher has. The manifest file may further define which signals or messages the launcher receives from the operating system. For example, the manifest file may define which events the event broadcaster 122 should send through (broadcast) to the launcher.

Apps may run either in the foreground 154 or in the background 156. Apps that run in the foreground are visible to a user of the digital device, while apps that run in the background are not visible to the user. In some systems, only one app may run in the foreground at any given time, while in other systems, a plurality of apps may run in the foreground simultaneously. Typically, several apps may simultaneously run in the background. Apps may be divided into two or more categories, e.g. distracting apps 150 and non-distracting apps 152. The launcher may keep track which apps belong to which category. For example, the launcher may maintain a list of all apps that are installed on the digital device and that are labelled as distracting.

The launcher 124 may define at least two operation modes. In a first operation mode, for example a restricted operation mode, the launcher may restrict access to a first category of apps while not restricting access to a second category of apps. For example, in the first operation mode, the launcher may restrict access to apps labelled as distracting apps using an application blocker 146. Restricting access to an app may comprise preventing the app from being launched, e.g. by not showing the app's icon on the home screen or by not launching the app when the app's icon is selected. Restricting access to an app may also comprise preventing an app from being run in the foreground. In an embodiment, the restricted operation mode may be the default operation mode of the launcher. In a second operation mode, for example an unrestricted operation mode, the launcher may not restrict access to apps in the first category.

The launcher 124 may switch between the first operation mode and the second operation mode using a key device. A key device may be connected to the digital device 100 using the wireless interface 102 or the wired interface 104. In response to detecting the connection with the key device, the operating system may instruct the event broadcaster 122 to broadcast a connection event. The connection event may comprise information about the connected device, e.g. device type, vendor ID, product ID, device ID, and/or device name. In an embodiment, the connection event may only be broadcast to apps that are registered with the operating system to receive the connection event. This registration may be performed using manifest file 130. The launcher may comprise an event listener 132 and a device/intent filter 134. When the event listener detects a connection event, the device/intent filter may check whether the connected device is a key device, for example by comparing the device ID to one or more predetermined IDs. In a different embodiment, filtering may be performed by the event broadcaster. Similarly, a disconnection event may be broadcast by the event broadcaster and detected by the launcher when the key device is disconnected.

Thus, in an embodiment, the launcher 124 may switch between the first operation mode and the second operation mode in response to receiving a connection event associated with the key device, and the launcher may switch between the second operation mode and the first operation mode in response to receiving a disconnection event associated with the key device. In such an embodiment, the key device must be connected to the digital device 100 to keep the launcher in the second operation mode. In a different embodiment, the key device may only be connected while the launcher initiates the switch between the first and second operation mode, or vice versa.

Some apps 1261-N may provide output even when they are not running in the foreground. For example, an app may send notifications. The launcher 124 may comprise a notification listener 136. The notification listener may be defined in the manifest file 130. In a restricted operation mode, the notification listener of the launcher may receive notifications from apps in the ‘restricted’, e.g. ‘distracting’ category. The launcher may subsequently store the received notifications in a notification buffer 142. The launcher may further comprise a notification blocker which is configured to prevent the notification form being shown, e.g. by deleting the notification. This way, a user does not notice a notification was sent by a restricted app, and hence, the user is not distracted. When the launcher switches to an unrestricted operation mode, the stored notifications may be outputted.

The launcher 124 may make use of usage access 138 for monitoring the use of distracting apps. The launcher may compile statistics about the use of distracting apps and display these usage statistics to the user. Additionally, the application blocker 146 may make use of the usage access 138 for blocking the use of restricted apps when in restricted operation mode. In a different embodiment, the launcher may be set up to be the device owner of the digital device, being able to disable restricted apps when in restricted operation mode.

FIG. 1B schematically depicts a specific example of a digital device 100, viz. a smartphone, with a plurality of physical and virtual key devices 180-188. The key devices may be connected to the digital device 100 via wireless interface 102 or wired interface 104. A physical key device may be, for example, a USB device 180, for example USB-C or USB-micro device, a Near Field Communication (NFC) device 188, or an AUX device 182. A virtual or software key device may be, for example, a Bluetooth input 184 or a Wi-Fi input 186. The smartphone may comprise I/O units including a screen 170, preferably a touch screen, buttons 166,168, a speaker 164, a microphone, a notification LED, et cetera.

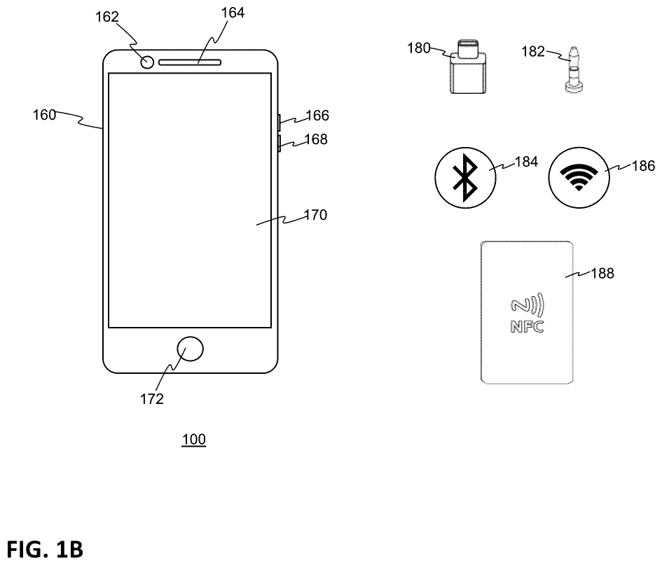

FIG. 2 depicts a flow diagram for selectively restricting interaction with apps installed on a digital device according to an embodiment of the invention. A system, typically a digital device such as a smartphone, comprises a launcher 202, an operating system (OS) 204, and an app 206 that has been labelled as a ‘distracting’ app. In this context, a ‘distracting app’ may refer to any app whose output is temporarily restricted or suppressed by a method according to this disclosure. It is submitted that an app that is labelled as ‘distracting’ need not be distracting, but may have been labelled because of security concerns, potential for embarrassment, or any other reason. Nevertheless, for ease of reference, however, any app whose output is temporarily restricted or suppressed will be referred to as a distracting app. All other apps, i.e. the apps not labelled as ‘distracting’, will be referred to as non-distracting apps. These are apps that are not restricted while the device is in a restricted operation mode. It is submitted that non-distracting apps may, however, be distracting for some users.

In the depicted example, the operating system 204 controls communication between apps installed on the device, including distracting app 206 and launcher 202. The OS also controls input/output (I/O) operations. An example of output may be showing a message on a screen of the device, playing a sound, or flashing a notification LED. The system may also comprise non-distracting apps. However, as the functioning of non-distracting apps is not altered, an example is not shown.

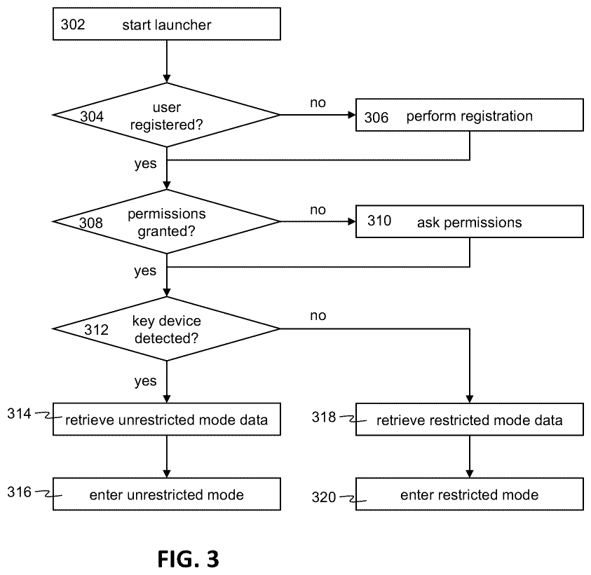

In a first step 210, a distracting app may create a notification while the device is in restricted operation mode, for example a message that has been received by a social media app. The distracting app sends the notification to the OS so that the OS may output the notification. The OS receives 212 the notification from the distracting app. The OS subsequently forwards 214 the notification to the launcher. A manifest file associated with the launcher may instruct the OS which notifications to forward to the launcher. In an embodiment, the OS may be instructed to only forward notifications from distracting apps. In a different embodiment, the OS may be instructed to forward all notifications, and the launcher may determine whether or not to output the notification based on the app from which the notification originates. Steps 214-220 will be discussed in more detail with reference to FIG. 4.

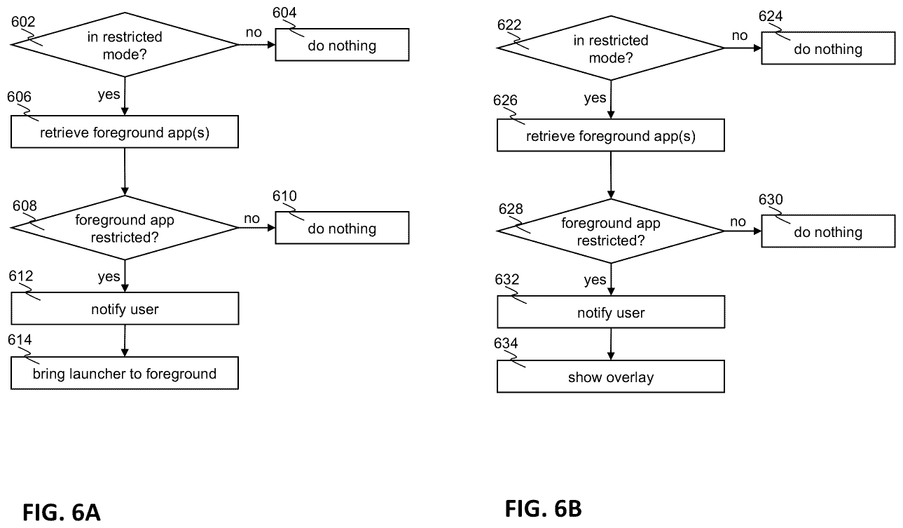

In a next step 216, the launcher 202 receives the forwarded notification. In an embodiment, the launcher may check the source of the notification. Optionally, the launcher may store 218 the notification or a copy of the notification. In an embodiment, the launcher may store certain information associated with the notification, rather than the notification itself. For example, the launcher may only store the number of notifications received for each distracting app. The launcher may then cancel 220 the original notification, causing the OS to cancel the notification 222. This prevents the OS from outputting the notification. It should be noted that the stored notification is not deleted in this step. In an embodiment, the launcher may explicitly instruct the OS not to output the notification. Steps 210-222 may be repeated a number of times while the device is in restricted operation mode. During this time, the launcher may receive and store notifications for a plurality of distracting apps. While the device is in restricted operation mode, the launcher may also prevent the distracting app from running in the foreground. This will be explained in more detail below, with reference to FIG. 6.

At a certain point in time, a user may connect 230 a key device, for example, the user may insert a USB key device to a USB connector of the digital device. The OS detects the connection with the key device and creates a connection event. Optionally, the OS may filter 232 the connection event based on e.g. type of device, device vendor ID and/or device ID of the connected device. This filter may be based on a manifest file associated with the launcher. Subsequently, the OS may notify the launcher of the connection event by broadcasting 234 the event. When connection event filtering (step 232) is performed by the OS, the OS may not need to broadcast a connection event to the launcher if a different device than a key device is connected. In a different embodiment, optional step 232 may be skipped and all connection events may be broadcast by the OS to the launcher. The launcher may then apply a filter to the connection event to determine whether the connected device is a key device. Intermediate solutions are also possible, with e.g. the OS filtering for device type and the launcher filtering for device ID.

After receiving 236 the connection event, the launcher may determine 238 the connection type, e.g. whether the key device was attached or detached. If the key device was attached, the launcher may switch 240 the device from restricted operation mode to unrestricted operation mode. When the key device is detached, the launcher may switch the device from unrestricted operation mode to restricted operation mode. In an embodiment, the launcher may wait a predetermined amount of time before switching. Such a delay may e.g. be advantageous if the key device is connected to a connector that is also used by a distracting app. Smartphones often have only one connector of any type.

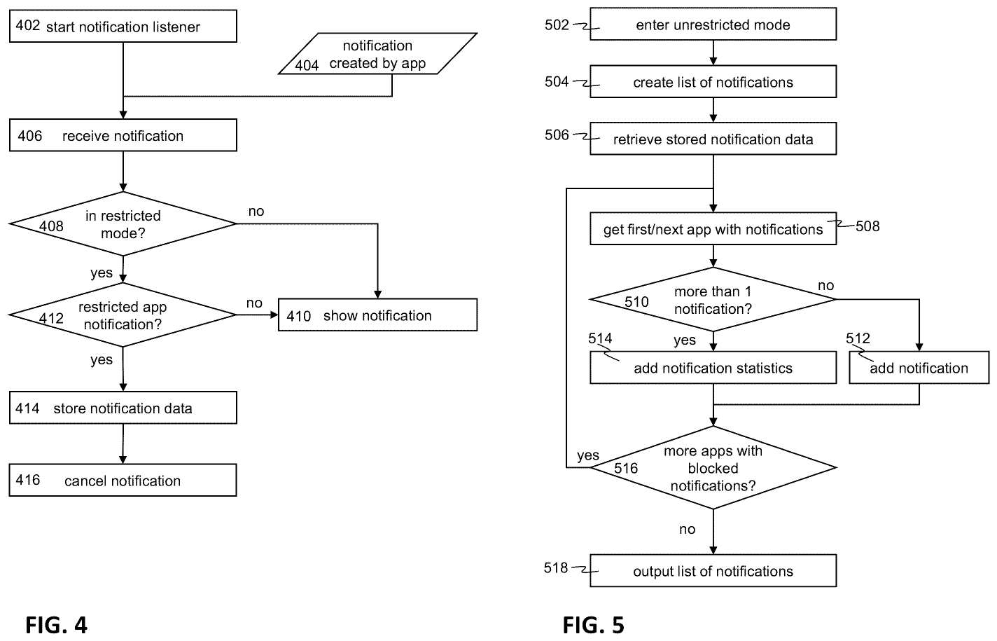

When the launcher switches from restricted operation mode to unrestricted operation mode, the launcher may send 250 the notifications that were stored in step 218 to be displayed 252 in the user interface by the OS. As was explained above with reference to step 218, the launcher may send an overview of the received notifications instead of the notifications themselves. Steps 250-252 will be discussed in more detail below with reference to FIG. 5.

In a step 260, the distracting app may create a notification while the device is in unrestricted operation mode. The distracting app sends the notification to the OS so that the OS may output the notification. The OS receives 262 the notification from the distracting app. The OS may subsequently forward 264 the notification to the launcher. In a different embodiment, the OS may be aware that the device is in unrestricted operation mode, and skip step 264. The launcher may receive 266 the notification, but as the device is in unrestricted operation mode, the launcher need not do anything in reaction to receiving the notification. In an embodiment, the launcher may store information related to the notification for e.g. statistical analysis. As in unrestricted operation mode, the launcher does not cancel the notification, the OS will display 268 or otherwise output the notification. In an embodiment, the OS may need to be specifically instructed by the launcher to output the notification. Steps 260-268 may be repeated multiple times and for a plurality of distracting apps, while the device is in unrestricted operation mode. The device may be switched back to restricted operation mode by e.g. disconnecting the key device, as was explained with reference to steps 230-240.

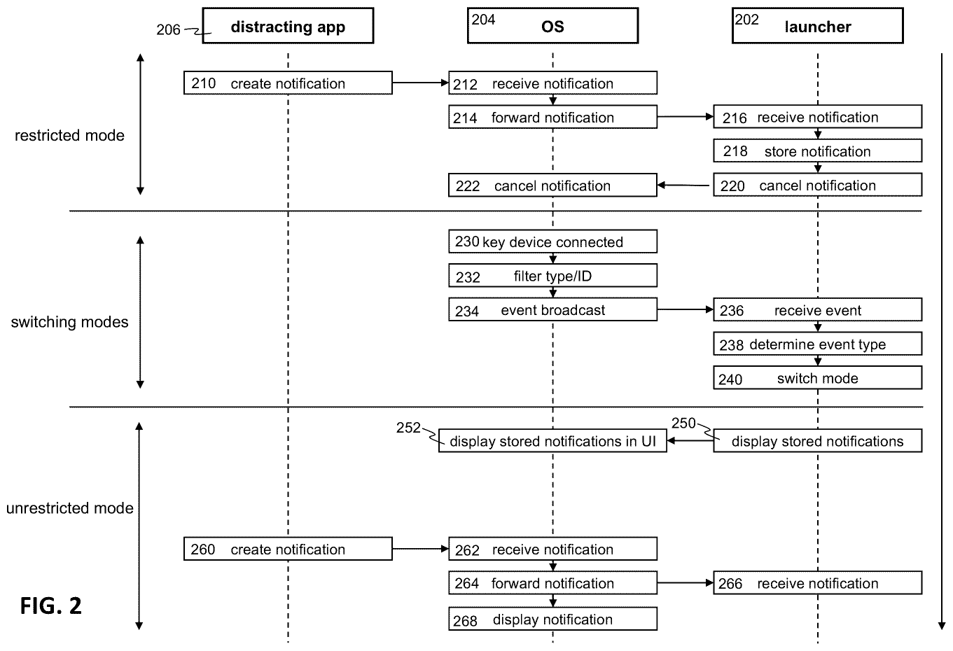

FIG. 3 depicts a flow diagram for starting up a launcher according to an embodiment of the invention. In a first step 302, the launcher is started. Typically, the launcher may be started automatically when the digital device is booted. In an optional step 304, the launcher may check 304 whether the user is registered, e.g. by consulting a database in the cloud. If the user is not registered, the launcher may execute 306 a user registration method. During registration, a user may be linked to e.g. a unique ID of the key device, or to a unique ID of the digital device. In an embodiment, a user may be linked to one key and a plurality of device, which may thus be configured to work with the registered key. In embodiments that do not implement step 306, a digital device may work with a plurality of different key devices. For example, a unique ID of the key device may be stored into local storage and/or into a database, possibly a cloud database. It may be possible to store more than one key device unique IDs per user, such that a user can use more than one key device with the digital device.

Subsequently, the launcher may check 308 whether the launcher has all necessary permissions to function. These permissions can include, but are not limited to, usage access and notification access. If a permission is missing, the launcher may prompt 310 the user to give permission. If no permissions are missing, the launcher may check 312 whether the key device is connected. If the key device is connected, the launcher may retrieve 314 information associated with an unrestricted (full functionality) operation mode, e.g. from local storage of the digital device. The launcher may then function as any known launcher and the device may enter 316 the unrestricted operation mode. If the key device is not connected, the launcher may retrieve 318 information associated with a restricted (limited functionality) operation mode, e.g. from local storage of the digital device. The device may then enter 320 a restricted operation mode and the launcher may block notifications from distracting apps and/or prevent distracting apps from running in the foreground. If a plurality of restricted operation modes have been defined, the launcher may automatically select a restricted operation mode based on parameters associated with the plurality of restricted operation modes, e.g. time of day, location, Wi-Fi SSID, et cetera. Alternatively, the launcher may prompt the user to choose one of the plurality of restricted operation modes.

FIG. 4 depicts a flow diagram for selectively blocking notifications according to an embodiment of the invention. In a first step 402, the notification listener is started. This step may need to be performed only once, for instance when the launcher is started. In some operating systems, the notification listener may be registered with the operation system. For example, on an Android operating system, a custom NotificationListener may be registered in AndroidManifest.xml. Other operating systems may have analogous steps. A notification 404 may be created by an app and may be received 406 by the notification listener as an incoming notification. For example, on an Android system, the incoming notification may be received through an overridden method onNotificationPosted (StatusBarNotification sbn) within the NotificationListener class.

In a next step 408, the launcher may determine whether the device is in restricted operation mode. In an embodiment, the launcher may determine whether the device is in restricted operation mode based on whether the key device is connected. If the device is in unrestricted operation mode, the launcher allows the operating system to show 410 the notification. This may comprise the launcher simply not performing any action that would prevent the operating system from showing the notification. In an embodiment, the launcher may actively control showing the notification.

If the device is in a restricted operation mode, the launcher may determine 412 whether the app that created or pushed the notification is considered a distracting app. If the notification was created by an app that is not considered distracting, the launcher allows the operating system to show 410 the notification. Steps 408 and 412 may also be executed in reverse order.

If the device is in a restricted operation mode and the notification was created by an app that is considered distracting, the launcher stores 414 information about the notification. This way, information about the notification may be shown once the device is switched to an unrestricted operation mode, as discussed below with reference to FIG. 5. The stored notification information may comprise a package name of the app that sent it, a message text, a content title and a time the notification was received. The notification may be stored in the form of a key-value pair, where the key comprises information identifying the app that created the notification and the value comprises information associated with the notification.

In a last step 416, the launcher may delete or otherwise cancel the notification. On an Android system, this step may be performed by the notification listener. On some systems, this step may require extracting a notification key prior to deletion of the notification.

FIG. 5 depicts a flow diagram for displaying information associated with selectively blocked notifications, according to an embodiment of the invention. In a first step 502, the digital device may switch to an unrestricted operation mode. For example, a user may connect a key device to the digital device. Alternatively, the digital device may switch to a different operation mode with a different set of restricted apps; for example, the device may switch from an operation mode where entertainment apps are considered distracting and work-related apps are not considered distracting to an operation mode where entertainment apps are not considered distracting and work-related apps are considered distracting.

Optionally, the launcher may first check whether any notifications have been stored in a previous operation mode that have not yet been shown. If there are no stored messages, the launcher may stop. If there are stored notification, the launcher may create 504 a (still empty) list of notifications that are to be outputted. The launcher may retrieve 506 stored notification data. In an embodiment, the notifications may have been stored as explained above with reference to step 410. The launcher may determine 508 a first app for which there are stored notifications. If the app is still considered distracting in the current operation mode, the launcher may proceed to the next stored notification. If the app is no longer considered distracting, the launcher may count 510 the number of notifications that were created by the app. If this number is one, the launcher may add 512 the app and the notification message to the list of notifications. The notification may then be deleted from the stored notification. If there is more than one notification, the launcher may add 514 statistics about the notifications to the list of notifications. For example, the launcher may add the number of blocked notifications created by the app. Optionally, the launcher may also add the most recent stored notification to the list of notifications. The notifications may then be deleted from the list of notifications. In a next step 516, the launcher may determine whether there are more apps from which notifications have been blocked. If so, steps 508-516 may be repeated until all apps for which there are stored notifications have been checked. In a last step 518, the launcher may output, e.g. display, the list of notifications.

Thus, for apps for which there is a plurality of stored notifications, the launcher may display information of the most recent notification, such as the message, the title and the time it arrived, along with the icon of the application, as well as the total amount of notifications from that application. For apps for which there is only one notification, the custom launcher may display the notification to the user in a list where all previously blocked notifications are shown, with information such as the message of the notification, the icon of the application, the title and the time it arrived. Alternatively, the launcher may instruct the OS to display the list of notifications.

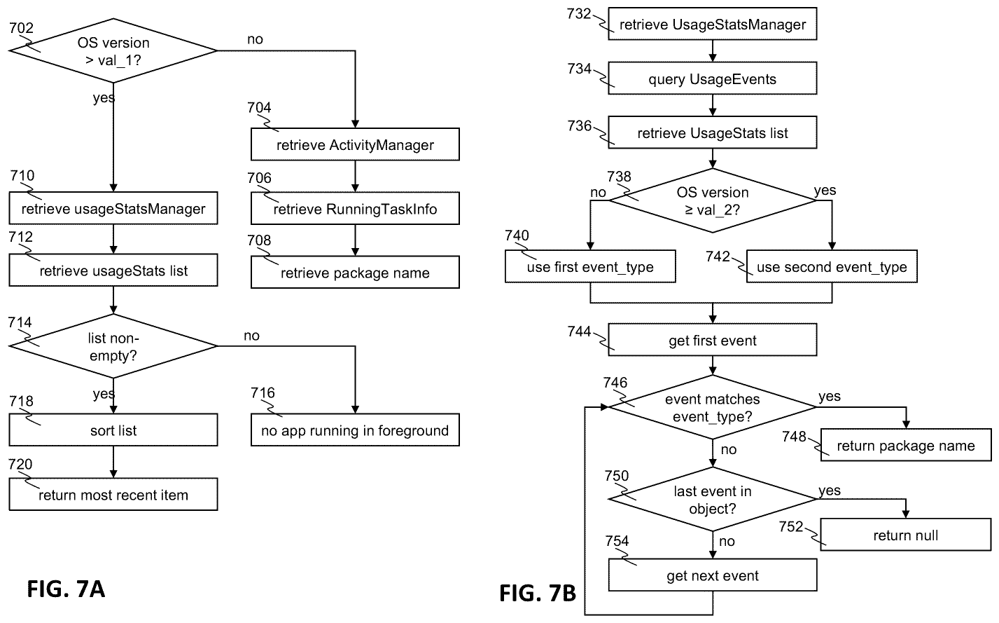

FIG. 6A depicts a flow diagram for selectively preventing an app from running in the foreground according to an embodiment of the invention. In a first step 602, the launcher may determine whether the digital device is running in a restricted operation mode, for instance by determining whether the key device is connected to the digital device. If the digital device is in an unrestricted operation mode, the launcher may stop 604 and not change which app is running in the foreground. Thus, every app can be used in a normal way. If the digital device is in a restricted operation mode, the launcher may, in a next step 606, determine which app is or which apps are currently running in the foreground. The launcher may do so using the method steps discussed with reference to FIG. 7A or 7B. In a different embodiment, the order of steps 602 and 606 may be reversed. The launcher may then determine 608 whether at least one app that is running in the foreground is considered a distracting app. If there is no distracting app running in the foreground, the launcher may do nothing 610. If at least one app that is running in the foreground is a restricted app, the launcher may optionally notify 612 the user that the app is a distracting app. The launcher may further notify the user that if he wishes to continue using the distracting app, he should switch to an unrestricted operation mode, for example by connecting the key device. The launcher may e.g. show the notification for a pre-determined amount of time, or wait a for confirmation by the user. The launcher then brings 614 itself to the foreground. Thus, the distracting app cannot be used. If there were several foreground apps, the launcher may either replace all foreground apps, or only the distracting app or apps. If the launcher occupies the entire foreground, the launcher may stop checking whether any app running in the foreground is a restricted app. If there is a plurality of apps running in the foreground and the launcher only puts itself in the foreground of a selected app that was detected running in the foreground, the launcher may continue to determine whether there are additional selected apps running in the foreground. In an embodiment, the method steps depicted in FIG. 6A may be repeated at variable or fixed intervals, e.g. every second or every few seconds.

FIG. 6B depicts a flow diagram for selectively preventing an app from running in the foreground according to an embodiment of the invention. In a first step 622, the launcher may determine whether the digital device is running in a restricted operation mode, for instance by determining whether the key device is connected to the digital device. If the digital device is in an unrestricted operation mode, the launcher may stop 624 and not change which app is running in the foreground. Thus, every app can be used in a normal way.

If the digital device is in a restricted operation mode, the launcher may, in a next step 626, determine which app is or which apps are currently running in the foreground. The launcher may do so using the method steps discussed with reference to FIG. 7A or B. In a different embodiment, the order of steps 622 and 626 may be reversed. The launcher may then determine 628 whether at least one app that is running in the foreground is considered a distracting app.

If there is no distracting app running in the foreground, the launcher may do nothing 630. If at least one app that is running in the foreground is a restricted app, the launcher may show 634 an overlay over the distracting app, thus making it clear to the user that this is a distracting app. The launcher may further show a message to the user using the overlay, for instance a message that if the user wishes to continue using the distracting app, the device should be switched to an unrestricted operation mode, for example by connecting the key device. Thus, by placing an overlay over the distracting app, user interaction with the distracting app is prevented and the distracting app cannot be used. If there were several foreground apps, the launcher may either show an overlay over all foreground apps, or only over the distracting app or apps. In an embodiment, the method steps depicted in FIG. 6B may be repeated at variable or fixed intervals, e.g. every second or every few seconds.

FIGS. 7A and 7B depict flow diagrams for retrieving an app running in the foreground according to an embodiment of the invention. The method steps depicted in FIGS. 7A and 7B may be specific to the Android operating system; other operating systems may have more or less similar steps for retrieving the package name of the current foreground app.

In a first example, depicted in FIG. 7A, the launcher may first check 702 whether a version number of the Android operating system running on the digital device is bigger than or equal to Build.VERSION_CODES.LOLLIPOP_MR1. If it is smaller, an ActivityManager object of the app may be retrieved 704 by calling context.getSystemService (android.content.Context.ACTIVITY_SERVICE), after which a RunningTaskInfo object of the foreground app may be retrieved 706 by calling getRunningTasks(1).get(0) on the ActivityManager object. The package name of the foreground app may be retrieved 708 by calling runningTaskInfo.topActivity.getPackageName( ) on the retrieved RunningTaskInfo object.

If the Android OS is bigger than or equal to LOLLIPOP_MR1, a usageStatsManager object may be retrieved 710 by calling context.getSystemService(Context.USAGE_STATS_SERVICE), after which a usage list List<UsageStats> may be retrieved 712 by calling usageStatsManager.queryUsageStats( ) for a specified time interval, e.g. 1 second, using UsageStatsManager.INTERVAL_DAILY. The launcher may then check 714 whether a non-empty usage list was retrieved, for example by checking whether the retrieved usage list is not null and the size of the list is bigger than zero. If there is no list or there are no elements in the list, the launcher may determine 716 that are no apps running in the foreground. Else, the launcher may sort 718 the usage list by a last time each app in the usage list was used, for example using the getLastTimeUsed( ) method from the UsageStats as a key in a SortedMap object, with the value being the UsageStats object itself. The package name from the app that is in the foreground may be retrieved 720 by e.g. calling sortedMap.get(sortedMap.lastKey( ).getPackageName( ) on the SortedMap object.

In a second example, depicted in FIG. 7B, the launcher may retrieve 732 the usageStatsManager by calling context.getSystemService(Context.USAGE_STATS_SERVICE). In a next step, the launcher may query 734 a UsageEvents object through the retrieved UsageStatsManager, after which the UsageEvents object may be retrieved 736 by calling usageStatsManager.queryEvents( ) for a specified time interval, e.g. 1 second in the past determined from the current System's millisecond time.

The launcher may then check 738 whether a version number of the Android operating system running on the digital device is bigger than or equal to a predetermined value, e.g., Build.VERSION_CODES.Q. If it is bigger than or equal, a first event type may be used 742, e.g. UsageEvents.Event.ACTIVITY_RESUMED. If the Android OS version number is smaller than the predetermined value, a second event_type may be used 740, e.g. UsageEvents.Event.MOVE_TO_FOREGROUND.

The UsageEvents object may consequently be iterated on, preferably going over every next UsageEvents. Event object in it. In particular, the launcher may get 744 a first event from the UsageEvents list. The event type of the UsageEvents. Event may be retrieved through the getEventType( ) method and may be compared 746 to the event_type selected in steps 738-742. If the retrieved event type of the UsageEvents.Event object is equal to the specified event_type, the package name of the UsageEvents.Event object may be returned 748. If there are more events in the UsageEvents object, the next event may be retrieved 754. If no UsageEvents.Event event type matched the specified event_type, a null may be returned 752.

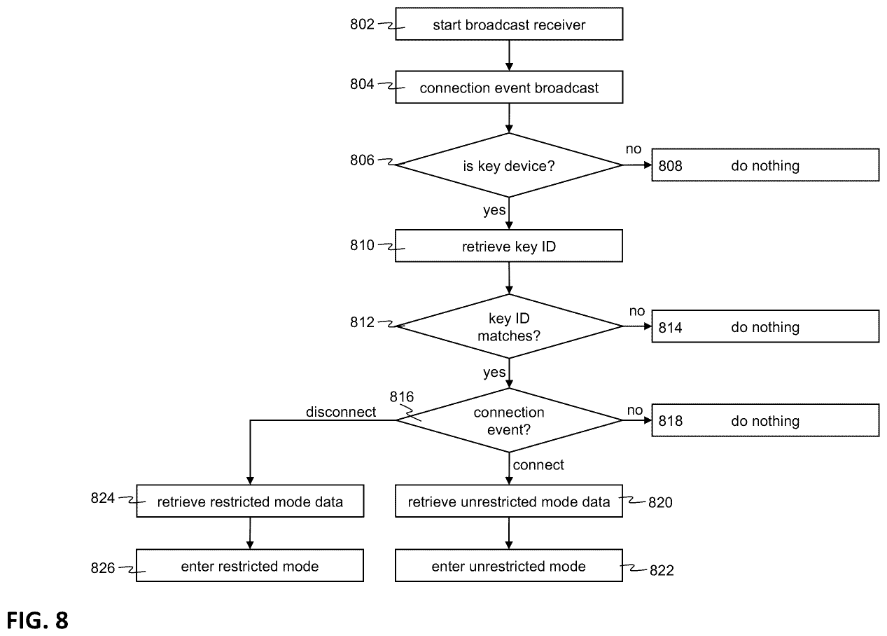

FIG. 8 depicts a flow diagram for switching operation modes in response to a key device being connected or disconnected according to an embodiment of the invention. In a first step 802, a broadcast receiver is started. In some operating systems, this step may need to be performed only once, for instance when the launcher is started. In some operating systems, the broadcast receiver may be registered with the operating system. For example, on an Android operating system, a custom BroadcastReceiver object, e.g. a UsbBroadcastReceiver object, may be created and registered in AndroidManifest.xml. Other operating systems may have analogous steps.

If a device is connected or disconnected, for instance a USB device, the launcher may receive 804 a connection event broadcast by the operating system. The operating system may filter for which devices a connection event may be broadcast to the launcher. This filter may be generic, for instance only filtering on connection type (e.g. USB, Wi-Fi, NFC, et cetera), or more specific. For example, using a USB key device on an Android OS, a device filter may be specified in e.g. XML-format with a product ID and vendor ID for the USB key. This device filter may be added in the meta-data for both USB_DEVICE_ATTACHED and USB_DEVICE_DETACHED events from the android.hardware.usb.action package. Also, the intent filter for both the USB events may be declared in the manifest file AndroidManifest.xml. If such a specific filter is used, the launcher may only receive a connection event if the USB device's product ID and vendor ID match the specified product ID and vendor ID. In a different embodiment, the launcher may perform checks to determine vendor ID and product ID. Yet other embodiments may use different filters. If the OS or the launcher determines 806 that the device that initiated the connection event is not a key device, nothing more needs to be done 808.

If the connected device is a key device, the launcher may optionally, in a next step 810, retrieve a unique ID (UID) of the key device. A UID may for example be retrieved using a combination of the device ID and device name, e.g. by using getDeviceId( ) and getDeviceName( ) methods of an android.hardware.usb.UsbDevice class. The launcher may then determine 812 whether the retrieved UID matches a predetermined or registered UID. The predetermined or registered UID may be stored on the digital device or e.g. on a server. If the retrieved UID does not match, the launcher ignores the key device and does nothing 814. Other embodiments may skip steps 810-814 and accept any key device.

If the key device is accepted, the launcher may determine the type of connection event. If the key device was connected, e.g. if the action of the incoming Intent equals (ignoring casing) UsbManager.ACTION_USB_DEVICE_ATTACHED, then the launcher may retrieve 820 unrestricted operation mode data and switch to an unrestricted (full functionality) operation mode. If the key device was disconnected, e.g. if the action of the incoming Intent equals (ignoring casing) UsbManager.ACTION_USB_DEVICE_DETACHED, then the launcher may retrieve 824 restricted operation mode data and switch 826 to a restricted (limited functionality) operation mode. If a plurality of restricted operation modes have been defined, the launcher may automatically select a restricted operation mode based on parameters associated with the plurality of restricted operation modes, e.g. time of day, location, Wi-Fi SSID, et cetera. Alternatively, the launcher may prompt the user to choose one of the plurality of restricted operation modes. In case the connection event was neither an indication that the key device was connected nor that the key device was disconnected, e.g. if both Strings from the UsbManager do not match, the launcher may do nothing 818.

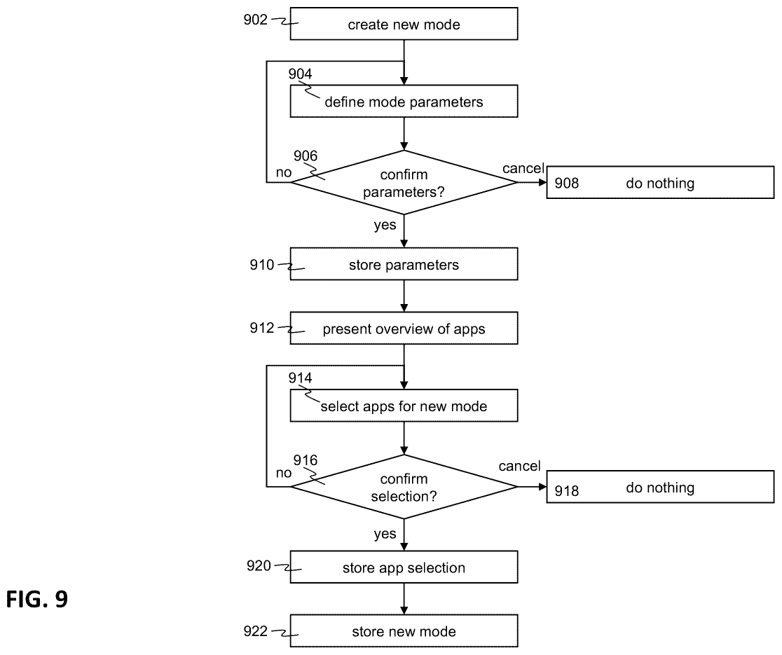

FIG. 9 depicts a flow diagram for defining an operation mode according to an embodiment of the invention. An example of an operation mode could be, but is not limited to, the described “Entertainment mode”, or “Productivity mode”. A user may instruct the launcher to create a new operation mode, for example by clicking a button. The launcher may then prompt the user to define parameters 904 for the new operation mode, for example a name of the operation mode, a colour of the operation mode, and factors that may be used to determine when the new operation mode should be the default operation mode, i.e. when the launcher should switch to the new operation mode if the user does not override the default behaviour, e.g. by connecting the key device. These factors can include, but are not limited to, GPS location, Wi-Fi access and network name, key device detection, time of day, or an algorithm determination based on previous usage data and user input. The launcher may suggest default values for one or more of these parameters. When the user has finished defining the parameters, the launcher may ask 906 the user to confirm the parameters. Optionally, the launcher may also display an overview or summary of the parameters. The user may then confirm the parameters, deny and return to step 904 to change the parameters, or cancel the procedure, after which nothing is stored 908 and any changed details will remain unchanged. If the user confirms the parameters, the parameters for new operation mode may be stored 910, for example to the local storage of the digital device. This step may also occur at a different point, e.g. immediately before or after step 920.

In a next step 912, the launcher may show the user an overview of all the applications stored and/or installed on the digital device. The launcher may then prompt the user to select 914 which apps should be restricted in the new operation mode. In an embodiment, the launcher may prompt the user to select the apps that should be restricted. Alternatively, the launcher may prompt the user to select the apps that should not be restricted. After or during the selection step, the launcher may present the user with the option to confirm 916 the app selection. Optionally, the launcher may also display an overview or summary of the selected apps. The user may then confirm the app selection, deny and return to step 914 to change the app selection, or cancel the process, so no changes will be saved 918. Optionally, if the new operation mode parameters were saved in step 910, these may be deleted if the user cancels the procedure If the user confirms the app selection, the selection may be stored 920 to e.g. local storage of the digital device. The launcher may then store the new operation mode in conjunction with the defined parameters and the selected apps.

When the launcher is being installed, the launcher may optionally skip steps 902-910 and only ask for a selection of apps that may be restricted. In an embodiment, a stored or predefined operation mode may be modified by executing one or more of method steps 904-922.

The current invention shows an example of storing the unique ID of the key device into local storage and into a database. It is clear to the skilled person that in some embodiments, it may be possible to store more than one unique ID of inputs per user, such that a user can use more than one key device with the digital device.

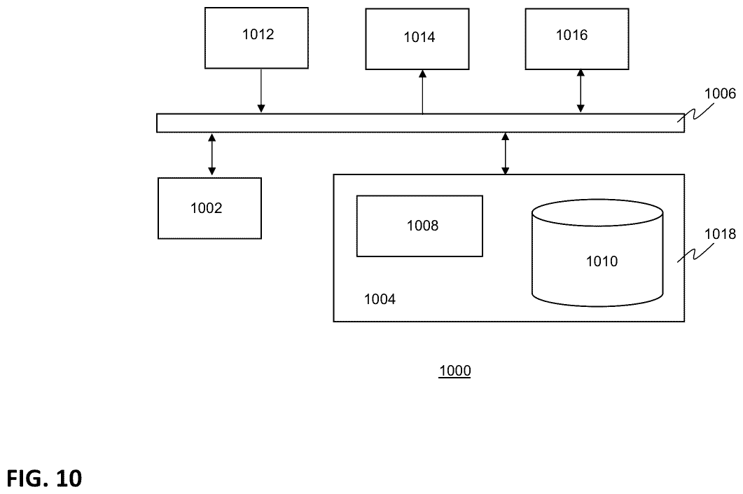

FIG. 10 is a block diagram illustrating exemplary data processing systems described in this disclosure. Data processing system 1000 may include at least one processor 1002 coupled to memory elements 1004 through a system bus 1006. As such, the data processing system may store program code within memory elements 1004. Further, processor 1002 may execute the program code accessed from memory elements 1004 via system bus 1006. In one aspect, data processing system may be implemented as a computer that is suitable for storing and/or executing program code. It should be appreciated, however, that data processing system 1000 may be implemented in the form of any system including a processor and memory that is capable of performing the functions described within this specification.

Memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive or other persistent data storage device. The processing system 1000 may also include one or more cache memories (not shown) that provide temporary storage of at least some program code in order to reduce the number of times program code must be retrieved from bulk storage device 1010 during execution.

Input/output (I/O) devices depicted as key device 1012 and output device 1014 optionally can be coupled to the data processing system. Examples of key device may include, but are not limited to, for example, a keyboard, a pointing device such as a mouse, or the like. Examples of output device may include, but are not limited to, for example, a monitor or display, speakers, or the like. Key device and/or output device may be coupled to data processing system either directly or through intervening I/O controllers. A network adapter 1016 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Operation modems, cable operation modems, and Ethernet cards are examples of different types of network adapter that may be used with data processing system 1000.

As pictured in FIG. 10, memory elements 1004 may store an application 1018. It should be appreciated that data processing system 1000 may further execute an operating system (not shown) that can facilitate execution of the application. Application, being implemented in the form of executable program code, can be executed by data processing system 1000, e.g., by processor 1002. Responsive to executing application, data processing system may be configured to perform one or more operations to be described herein in further detail.

In one aspect, for example, data processing system 1000 may represent a client data processing system. In that case, application 1018 may represent a client application that, when executed, configures data processing system 1000 to perform the various functions described herein with reference to a “client”. Examples of a client can include, but are not limited to, a personal computer, a portable computer, a mobile phone, or the like.

In another aspect, data processing system may represent a server. For example, data processing system may represent an (HTTP) server in which case application 1018, when executed, may configure data processing system to perform (HTTP) server operations. In another aspect, data processing system may represent a module, unit or function as referred to in this specification.

As described above, versions of the system using Google Android may make use of usage access for monitoring the use of distracting apps. In other embodiments, the system uses the accessibility permission on Google Android to monitor the use of distracting apps, as an alternative to using the usage access permission. This is another way to see which apps are in the foreground on Google Android.

Various platforms contain different device logic for allowing a user to launch applications. As described above, all versions of Google Android operating system provide a “Launcher” application, for example some versions provide the Google Now Launcher (e.g., the Google Pixel), through which the user can launch other applications. However, users of Google Android operating system do not require a launcher application to block other applications, any application can use blocking APIs to provide the ability to block certain applications at certain times or under certain conditions as described herein. Other platforms, such as Apple IOS allow the user to place applications on a home screen and launch them directly. These platforms still run a shell application, such as Apple Springboard, that while not apparent to the user provides the home screen functionality. In some embodiments, a launcher application as described herein encompasses these other types of device logic for a user to launch applications, and the system described herein operates to determine whether or not a particular application that the user requests to launch should be allowed to run based on policies of the system, such as the presence or absence of a dongle. It will be understood by those skilled in the art that one purpose of the system described herein is to control when applications are allowed to be launched by the user, regardless of the particular manner in which each platform allows those applications to be launched. Even if new ways of launching applications are introduced, the system may be updated to control whether these applications can be launched based on policies determined by the system. Apple has many operating systems and has at times split one operating system into separate versions. As used herein, the term iOS refers to any of Apple's operating systems that operate in the manner described herein, and could encompass macOS, iPadOS, homeOS, tvOS, visionOS, and future operating systems that Apple may provide.

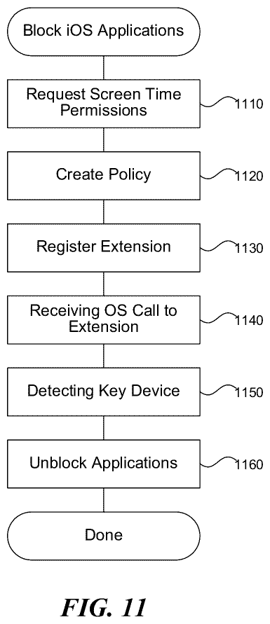

FIG. 11 depicts a flow diagram for blocking launching of applications when a key device is not near a user device on digital devices running an Apple operating system, according to an embodiment of the invention.

Beginning in block 1110, requesting Screen Time permissions to extend the operating system's application blocking capabilities. Apple operating systems provide a requestAuthorization method through the AuthorizationCenter object. The shared AuthorizationCenter instance allows a blocking application to provide parental controls or blocking applications/websites for individuals, which allow blocking which other applications, websites, and content can be accessed according to various policies. A policy may include a schedule of when various applications, websites, or content can be accessed by the user, how the key device determines which applications can be accessed, and so forth.

Continuing in block 1120, creating a policy that determines which applications will be blocked and a schedule during which they will be blocked. Apple operating systems provide a FamilyActivityPicker that allows selecting tokens for applications, websites, and categories that a blocking application wants to block. In some embodiments, up to 49 applications or other tokens can be selected to be either blocked or unblocked. The blocking application stores these tokens in local storage along with a name for the policy, time schedule during which the policy blocks, what barrier is used with the policy (e.g., an NFC key device), any location at which the schedule will be blocked or unblocked, and so on. In addition to schedules, the blocking application can also create application limits, which means someone can use an application X minutes per day, and after that it gets blocked. This uses a similar process as described above, but in the DeviceActivityMonitor extension the relevant method is eventDidReach Threshold.

Continuing in block 1130 registering an extension that the operating system calls when a blocked application is launched by the user. When a schedule is created, the blocking application initiates the monitoring of blocked applications, websites, or other content according to the specified schedule. This happens by calling the startMonitoring method from the DeviceActivityCenter. Once this is called, Apple operating systems handle the background process of detecting whether applications or websites should be blocked. If the intervalDidStart is called for a schedule, the blocking application starts blocking applications for that schedule from the intervalDidStart callback, by creating a new ManagedSettingsStore (e.g., “store”). The blocking application accesses the schedules from local storage. The store has ShieldSettings that declare the schedule's application tokens, website tokens, and category tokens. This will ensure those tokens are now being blocked—the blocking detection is handled by the operating system.

Continuing in block 1140, when the operating system detects that a blocked application is being opened, receiving a call to the registered extension to block the application from running. When a blocked app/website is opened, Apple operating systems will launch the blocking application's ShieldConfigurationDataSource extension and block the application or website. This allows the user to define when the user does not want to be able to use a particular type of application, such as entertainment applications at work, or work applications during leisure hours, and have the operating system and blocking application work in concert to carry out the blocking. When the user wants to override the policy, the user can go get the key device, request to unblock the previously blocked application or website, bring the key device near to the user's digital device, and access the blocking application to turn off blocking.

Continuing in block 1150, detecting the presence of a key device that allows unblocking blocked applications. When the user wants to access blocked applications or websites, the user runs the blocking application and satisfies the barrier defined by the policy (e.g., bringing the NFC key device near to the digital device so the digital device's NFC hardware can detect the NFC key device). Once the barrier is satisfied, the blocking application starts unblocking the relevant schedules by accessing the ManagedSettingsStore through the relevant store name. Once this store is accessed, the blocking application calls clearAllSettings on the store to empty the store. This will stop Apple operating systems from blocking the applications and websites in the store.

Continuing in block 1160, unblocking the previously blocked applications so that the user can run the blocked applications. After a certain time period (e.g., 20 minutes), the blocking application again calls the startMonitoring method from the DeviceActivityCenter in Apple operating systems to start blocking again. This call makes sure that after those 20 minutes, the blocking application gets a callback in the DeviceActivityMonitor extension, in the intervalDidStart method, with the SetBackToBlocking store name. This is an indication to start blocking again. After block 1160, these steps conclude.

In some embodiments, a single key device can unlock multiple user digital devices. For example, a household might acquire a single key device, such as an NFC tag, that they share to unlock their digital devices (e.g., smartphones or tablets). In other embodiments, a single key device is linked to a specific digital device, and can only be used to implement policies on that digital device.

In some embodiments, key devices and digital devices form an N-to-N relationship, where one key device might unlock multiple digital devices, multiple key devices might unlock one digital device, and/or multiple key devices might unlock multiple digital devices.

In some embodiments, the system may provide purpose-based key devices for allowing the user to perform specific purpose-based policies on a digital device. For example, a work-purposed key device may be tied to a policy that allows the user to launch applications commonly used for work on the user's digital device, such as an email application.

In some embodiments, the system switches a digital device to a restricted mode when a key device is present. This is the opposite of much of the description above where the presence of a key device triggers an unrestricted mode in the digital device.

In some embodiments, the system allows multiple schedules to be active at the same time. For example, Schedule A may run from Monday to Friday 8 AM to 6 PM and Schedule B may run from Friday through Sunday all day. Each schedule represents a policy that allows particular applications to run during the scheduled time. The system may perform a union operation such that any application in either of the schedules can run during the overlapping time or an intersection operation such that only applications included in both of the schedules are allowed to run. This type of behavior may be configurable by the user or an operator of the system to determine which applications will run when schedules overlap.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

I/We claim:

1. A computer-implemented method to block launching of applications when a key device is not near a user device on digital devices running an operating system capable of blocking applications from running, the method comprising:
requesting permissions to extend the operating system's application blocking capabilities;
creating a policy that determines which applications will be blocked and a schedule during which the applications will be blocked;
registering an extension that the operating system calls when a blocked application is launched by the user;
when the operating system detects that a blocked application is being opened, receiving a call to the registered extension to block the application from running;
detecting the presence of a key device that allows unblocking blocked applications;
unblocking the previously blocked applications so that the user can run the blocked applications,
wherein the preceding steps are performed by at least one processor.

2. The method of claim 1 wherein requesting permissions comprises calling a requestAuthorization method through an AuthorizationCenter object, wherein a shared AuthorizationCenter instance allows a blocking application to provide parental controls or blocking applications/websites for individuals, which allow blocking which other applications, websites, and content can be accessed.

3. The method of claim 1 wherein creating the policy comprises accessing a FamilyActivityPicker object that allows selecting tokens for applications, websites, and categories that a blocking application wants to block.

4. The method of claim 1 wherein creating the policy comprises storing a name for the policy, time schedule during which the policy blocks, and what barrier is used with the policy.

5. The method of claim 1 wherein creating the policy comprises defining an NFC key device must be present to unblock applications.

6. The method of claim 1 wherein creating the policy comprises creating application limits that determine how many minutes per day the user can use a particular application, after which the particular application will be blocked.

7. The method of claim 1 wherein registering the extension comprises, when a schedule is created, the blocking application initiates the monitoring of blocked applications, websites, or other content according to the specified schedule.

8. The method of claim 1 wherein registering the extension comprises the operating system handles the background process of detecting whether applications or websites should be blocked based on the defined policy.

9. The method of claim 1 wherein registering the extension comprises, if a intervalDidStart method is called for a schedule by the operating system, the blocking application starts blocking applications for that schedule from an intervalDidStart callback, by creating a new ManagedSettingsStore object.

10. The method of claim 1 wherein registering the extension comprises, managing a local storage that has ShieldSettings that declare the schedule's application tokens, website tokens, and category tokens that are blocked by the operating system.

11. The method of claim 1 wherein receiving a call to the registered extension comprises the operating system launching the blocking application's ShieldConfigurationDataSource extension and blocking the application or website, so that the user defines when the user does not want to be able to use a particular type of application and have the operating system and blocking application work in concert to carry out the blocking.

12. The method of claim 1 wherein detecting the presence of the key device comprises detecting that the user brought an NFC key device near to the digital device so that the digital device's NFC hardware can detect the NFC key device, and in response to detecting that the user brought the NFC key device near to the digital device, the blocking application unblocks one or more relevant schedules by accessing the ManagedSettingsStore through a relevant store name to find a relevant store, and once the relevant store is accessed, the blocking application calls clearAllSettings on the relevant store to empty the relevant store to stop the operating system from blocking the applications and websites in the relevant store.

13. The method of claim 1 further comprising, after unblocking the previously blocked applications, after a reset time period, the blocking application calls the startMonitoring method from the DeviceActivityCenter in the operating system to start blocking the previously blocked applications again.

14. A digital device, preferably a smartphone, comprising a memory storing one or more applications and an operating system, at least one processor coupled to the memory, and a connector for communicatively coupling the digital device to a key device, wherein the processor is configured to perform executable operations comprising:
requesting Screen Time permissions to extend the operating system's application blocking capabilities;
creating a policy that determines which applications will be blocked and a schedule during which the applications will be blocked;
registering an extension that the operating system calls when a blocked application is launched by the user;
when the operating system detects that a blocked application is being opened, receiving a call to the registered extension to block the application from running;
detecting the presence of a key device that allows unblocking blocked applications;
unblocking the previously blocked applications so that the user can run the blocked applications,
wherein the preceding steps are performed by at least one processor.

15. The device of claim 14 wherein creating the policy comprises storing a name for the policy, time schedule during which the policy blocks, and what barrier is used with the policy.

16. The device of claim 14 wherein receiving a call to the registered extension comprises the operating system launching the blocking application's ShieldConfigurationDataSource extension and blocking the application or website, so that the user defines when the user does not want to be able to use a particular type of application and have the operating system and blocking application work in concert to carry out the blocking.

17. The device of claim 14 wherein detecting the presence of the key device comprises detecting that the user brought an NFC key device near to the digital device so that the digital device's NFC hardware can detect the NFC key device, and in response to detecting that the user brought the NFC key device near to the digital device, the blocking application unblocks one or more relevant schedules by accessing the ManagedSettingsStore through a relevant store name to find a relevant store, and once the relevant store is accessed, the blocking application calls clearAllSettings on the relevant store to empty the relevant store to stop the operating system from blocking the applications and websites in the relevant store.

18. A non-transitory computer-readable medium comprising instructions for controlling a computer system to block launching of applications when a key device is not near a user device on digital devices running an operating system, wherein the instructions, upon execution, cause a processor to perform actions comprising:
requesting Screen Time permissions to extend the operating system's application blocking capabilities;
creating a policy that determines which applications will be blocked and a schedule during which the applications will be blocked;
registering an extension that the operating system calls when a blocked application is launched by the user;
when the operating system detects that a blocked application is being opened, receiving a call to the registered extension to block the application from running;
detecting the presence of a key device that allows unblocking blocked applications;
unblocking the previously blocked applications so that the user can run the blocked applications,
wherein the preceding steps are performed by at least one processor.

19. The medium of claim 18 wherein receiving a call to the registered extension comprises the operating system launching the blocking application's ShieldConfigurationDataSource extension and blocking the application or website, so that the user defines when the user does not want to be able to use a particular type of application and have the operating system and blocking application work in concert to carry out the blocking.

20. The medium of claim 18 wherein detecting the presence of the key device comprises:
detecting that the user brought an NFC key device near to the digital device so that the digital device's NFC hardware can detect the NFC key device, and
in response to detecting that the user brought the NFC key device near to the digital device:
the blocking application unblocks one or more relevant schedules by accessing the ManagedSettingsStore through a relevant store name to find a relevant store, and
once the relevant store is accessed, the blocking application calls clearAllSettings on the relevant store to empty the relevant store to stop the operating system from blocking the applications and websites in the relevant store.
